(19) United States
(12) Patent Application Publication
(10) Pub. No.: US 2023/0205872 A1
(43) Pub. Date: Jun. 29, 2023

(54) METHOD AND APPARATUS TO ADDRESS ROW HAMMER ATTACKS AT A HOST PROCESSOR

(71) Applicant: Advanced Micro Devices, Inc., Santa Clara, CA (US)

(72) Inventors: Jagadish B. Kotra, Austin, TX (US); Onur Kayiran, Fairport, NY (US); John Kalamatianos, Boxborough, MA (US); Alok Garg, Boxborough, MA (US)

(21) Appl. No.: 17/561,170

(22) Filed: Dec. 23, 2021

(51) Int. Cl. G06F 21/55

(52) U.S. Cl. CPC G06F 21/554; G06F 2221/034

(57) ABSTRACT

A method includes receiving an indication that a number of activations of a memory structure exceeds a threshold number of activations for a time period, and in response to the indication, throttling instruction execution for a thread issuing the activations.

### BACKGROUND

Because of high memory intensive workloads and many core systems, demand for high dynamic random access memory (DRAM) capacity is increasing more than ever. One way to increase DRAM capacity is to scale down memory technology via reducing the proximity and size of cells and packing more cells in the same die area.

Recent studies show that because of high process variation and strong parasitic capacitances among cells of physically adjacent wordlines, wordline electromagnetic coupling (crosstalk) considerably increases in technology nodes below the 22 nm process node. Frequently activating and closing wordlines exacerbates the crosstalk among cells leading to disturbance errors in adjacent wordlines, thereby endangering the reliability of present and future DRAM technologies. In addition, wordline crosstalk provides attackers with a mechanism for intentionally inducing errors in the memory, such as main memory. The malicious exploit of crosstalk by repeatedly accessing a word line is known as “row hammering”, where the row hammering threshold refers to the minimum number of wordline accesses performed before the first error occurs.

### BRIEF DESCRIPTION OF THE DRAWINGS

The present disclosure is illustrated by way of example, and not by way of limitation, in the figures of the accompanying drawings.

FIG. 1 illustrates an embodiment of a computing system that supports throttling instruction execution in response to row hammer attacks.

FIG. 2 illustrates an embodiment of a memory controller including a row hammer detection circuit.

FIG. 3 illustrates a processor core that supports throttling instruction execution in response to row hammer attacks, according to an embodiment.

FIG. 4 illustrates a process of detecting a row hammer attack, according to an embodiment.

FIG. 5 illustrates a process of mitigating a row hammer attack by throttling execution of an aggressor thread, according to an embodiment.

### DETAILED DESCRIPTION

The following description sets forth numerous specific details such as examples of specific systems, components, methods, and so forth, in order to provide a good understanding of the embodiments. It will be apparent to one skilled in the art, however, that at least some embodiments may be practiced without these specific details. In other instances, well-known components or methods are not described in detail or are presented in a simple block diagram format in order to avoid unnecessarily obscuring the embodiments. Thus, the specific details set forth are merely exemplary. Particular implementations may vary from these exemplary details and still be contemplated to be within the scope of the embodiments.

The following description details various hardware mechanisms for mitigating row hammer attacks. In one embodiment, a detection circuit identifies threads that are performing row hammer attacks targeting memory rows in a memory device (e.g., a DRAM device). The detection circuit indicates the aggressor thread to a host processing unit (e.g., central processing unit (CPU), graphics processing unit (GPU), etc.) that is executing the thread. The processing unit responds to the indication by throttling the aggressor thread to decrease the frequency of memory accesses at the targeted rows below a row hammering threshold, thus mitigating the row hammer attack. An embodiment of a processing unit includes mechanisms for stalling instructions or micro-operations in various stages of its processor core pipeline. These mechanisms are used to throttle aggressor threads with reduced impact on co-running threads, which are possible victims of the row hammer attack. Row hammer attacks occur when load or store instructions are executed by the processing unit; thus, row hammer aware throttling of aggressor threads can be performed at the fetch, dispatch, and load/store execution stages of the pipeline. Throttling of an aggressor thread can also be achieved by mechanisms such as dynamic frequency and voltage scaling (DFVS), which can change the rate at which a processor core executing the aggressor thread executes instructions.

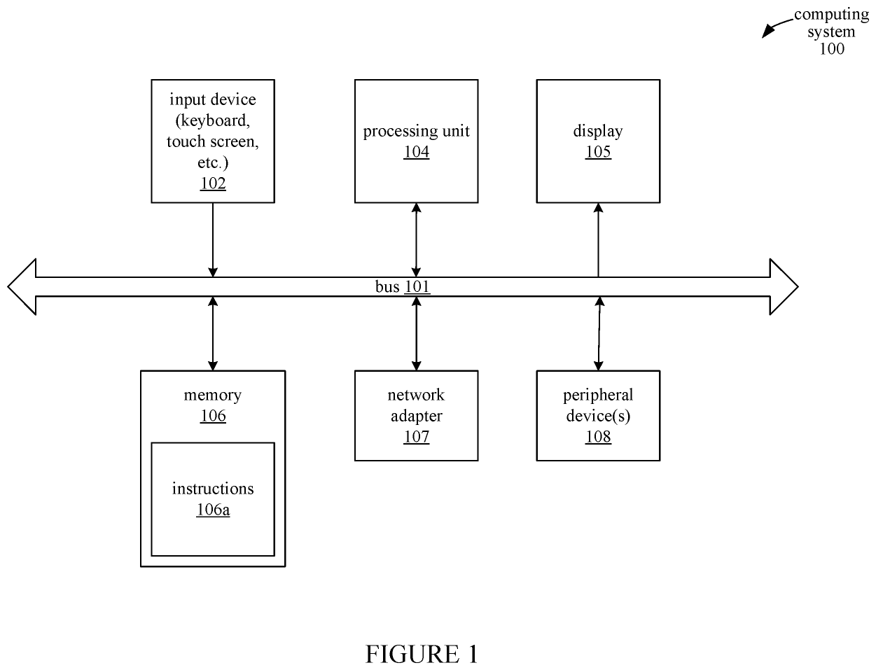

FIG. 1 illustrates an embodiment of a computing system 100 which implements the mechanism for detecting and throttling aggressor threads that are performing row hammer attacks, as described above. In general, the computing system 100 is embodied as any of a number of different types of devices, including but not limited to a laptop or desktop computer, mobile phone, server, system-on-chip, etc. The computing system 100 includes a number of components 102-108 that can communicate with each other through a bus 101. In computing system 100, each of the components 102-108 is capable of communicating with any of the other components 102-108 either directly through the bus 101, or via one or more of the other components 102-108. The components 101-108 in computing system 100 are contained within a single physical casing, such as a laptop or desktop chassis, or a mobile phone casing. In alternative embodiments, some of the components of computing system 100 are embodied as peripheral devices such that the entire computing system 100 does not reside within a single physical casing.

The computing system 100 also includes user interface devices for receiving information from or providing information to a user. Specifically, the computing system 100 may include an input device 102, such as a keyboard, mouse, touch-screen, microphone, wireless communications receiver or other device for receiving information from the user. The computing system 100 may display information to the user via a display 105, such as a monitor, light-emitting diode (LED) display, liquid crystal display, or other output device.

Computing system 100 additionally includes a network adapter 107 for transmitting and receiving data over a wired or wireless network. Computing system 100 also includes one or more peripheral devices 108. The peripheral devices 108 may include mass storage devices, location detection devices, sensors, input devices, or other types of devices that can be used by the computing system 100.

Computing system 100 includes a processing unit 104 that receives and executes instructions 106a that are stored in the main memory 106. As referenced herein, processing unit 104 represents a processor “pipeline”, and could include central processing unit (CPU) pipelines, graphics processing unit (GPU) pipelines, or other computing engines. Main memory 106 is part of a memory subsystem of the computing system 100 that includes memory devices used by the computing system 100, such as random-access memory (RAM) modules, read-only memory (ROM) modules, hard disks, and other non-transitory computer-readable media.

In addition to the main memory 106, the memory subsystem also includes cache memories, such as L2 or L3 caches, and/or registers. Such cache memory and registers are present in the processing unit 104 or on other components of the computing system 100.

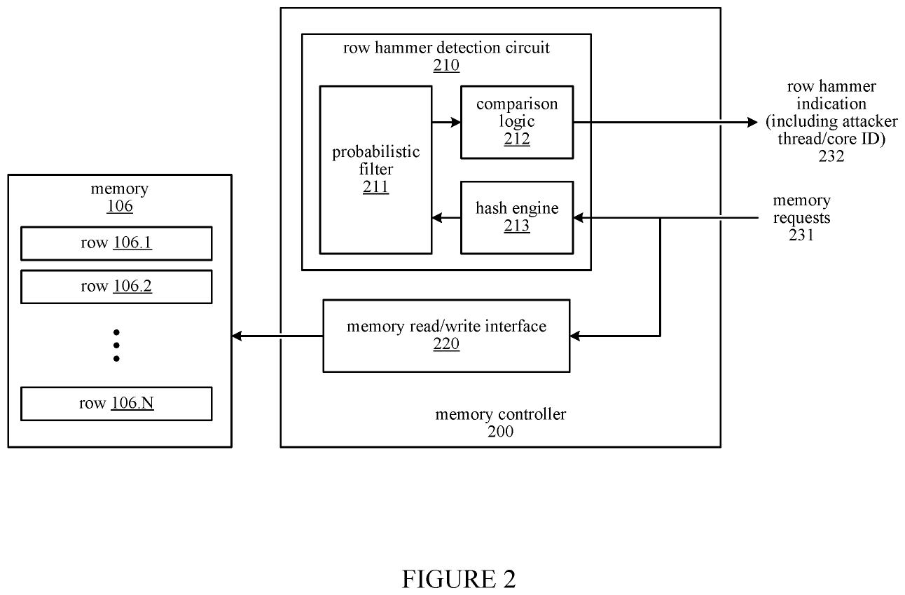

FIG. 2 illustrates a row hammer detection circuit 210 implemented in a memory controller 200, according to an embodiment. The memory controller 200 receives memory requests 231 from the processing unit 104 and includes a read/write interface 220 for reading or writing data to the memory 106 according to the requests 231. The detection circuit 210 generates an indication of a row hammer attack when a number of activations (i.e., due to read or write accesses) of a memory structure (e.g., memory rows 106.1-106.N) exceeds a threshold number of activations for a time period. When a row hammer attack is detected, an identifier of the aggressor thread or a processor core executing the aggressor thread is sent via an interconnect (e.g., bus 101) to the host processing unit 104 where the aggressor thread is being executed. The processing unit 104 responds by throttling execution of the aggressor thread's instructions at one or more stages in the processing pipeline. In an embodiment, the aggressor identification may indicate an aggressor process rather than a particular thread within the process.

To detect a row hammer attack, the detection circuit 210 determines whether a particular memory structure, such as a DRAM row, is receiving too many activations within a predetermined time period. In one embodiment, the detection circuit 210 maintains a counter for each memory row to keep track of the number of activations received within the time period (e.g., in the last w cycles, where w defines the length of the time window). In one embodiment, the counters are reset every w cycles. Each memory row being monitored has its row identifier associated with a thread identifier for each possible aggressor thread that has accessed the memory row within the time period. Each pair of row and thread identifiers is further associated with a count value indicating the number of activations of the identified memory row by the identified thread within the time period. When the number of activations of the memory row exceeds a threshold number of activations, the thread is determined to be an aggressor. Consequently, the detection circuit 210 communicates the aggressor's thread identifier 232 to the processor core in which it is being executed so the aggressor thread will be throttled.

Recording a count value for every row and thread pair can consume a large amount of memory, so for tracking a larger number of memory rows, one embodiment includes a probabilistic filter 211, to keep track of count values for each memory row and potential aggressor thread. In one embodiment, the filter 211 is a counting Bloom filter, in which the hash engine 213 contains logic for calculating multiple (k) hashes. When a memory row is activated by a thread, k hash results are calculated based on applying each of the k hash functions to the memory row identifier. Each of the k hash results corresponds to a counter position, and each of the k counters is incremented when the thread activates the row. The smallest count value among these k counters indicates the lower bound for the number of times the row has been activated in the time period (i.e., since the counters were last reset). For example, a count value of m indicates that the row has been activated at least m times since the last counter reset. The comparison logic 212 compares the smallest count value to the row hammer threshold and, if the count value exceeds the row hammer threshold (meaning all k counters in the group are above the threshold), throttling is enabled via transmission of the row hammer indication 232 to the processing unit 104. In one embodiment, multiple Bloom filters are used with overlapping time periods (i.e., resetting each filter's counters in round robin order) so that resetting the counters does not cause all information to be lost at once.

An alternative embodiment includes a second counting Bloom filter indexed by thread identifiers. When the count value exceeds a first threshold for a memory row, as indicated by the first Bloom filter, further incoming activations to that memory row would be tracked for different threads in the second Bloom filter. When the number of activations from any thread exceeds a second row hammer threshold, then a row hammer indication 232 is generated and the thread identifier is reported to the processing unit 104 for throttling.

In one embodiment, a single counting Bloom filter 211 is used to track activations of the memory rows 106.1-106.N by different threads so that aggressor threads can be throttled without throttling non-aggressor threads. When a memory row is activated, the hash engine 213 calculates the k hash results based on 1) a thread or process identifier for a thread or process issuing an activation, in combination with 2) a row identifier of the memory row being activated. This set of k hash results is used to determine which counters to increment in the filter 211. When the smallest of these count values exceeds the row hammer threshold, the thread identified by the thread identifier is determined to be an aggressor thread, and its thread identifier is sent to the processing unit 104 so that the specific thread is throttled.

In an alternative embodiment, the detection circuit 210 tracks the most frequently accessed memory rows in a set of activations whose contribution exceeds a certain threshold proportion of the total activations. That is, a memory row is tracked if the number of activations of the memory row exceeds the threshold proportion of the total activations for a given time period. For a row hammer attack that targets a few memory rows at a time, the activations from the row hammer attack contribute a larger percentage of traffic seen by the memory controller and can be easier to identify by this approach. In one embodiment, the process identifier (ASID), thread identifier, and/or CPU core identifier issuing the memory requests are associated with the activated memory rows, so that the source of the memory traffic can be identified and throttled when row hammering is detected.

As illustrated in FIG. 2, the row hammer detection circuit 210 resides in the memory controller 200. The memory controller has ready access to the information used for row hammer detection, such as the thread identifiers of the threads causing activations and the row identifiers for the memory rows where the activations are sent. In alternative embodiments, the detection circuit 210 resides at other locations in the system 100. For example, the detection circuit 210 can be located at interface ports between the processor core and non-core components of the system 100, at a global synchronization point of the system 100, at a last-level private cache, at a load/store unit of the processor core, etc. Monitoring for row hammer attacks can be performed in these locations because the physical addresses of memory requests are available, and the target memory row can be statically identified using memory address mapping configuration bits (i.e., the mapping of a physical address to a memory row is statically fixed at these locations).

For embodiments in which the detection circuit is placed in one of these locations, row hammer attacks are detected earlier because the aggressor memory requests pass through these locations prior to reaching the memory controller. In addition, row hammer detection can be performed with a lower area and power cost. For example, a system with 128 memory channels would have 128 row hammer detection circuits, with one detection circuit per memory controller. However, the number of CPU core complexes is likely to be much fewer (e.g. 8 or 16). Thus, placing one detection circuit per core complex results in fewer detection circuits used for obtaining visibility to all of the memory requests. In addition, placing the detection circuitry nearer to the core as described above can result in higher detection accuracy, since the temporal proximity of the memory requests of the attacker thread targeting a subset of memory rows is much higher when observed closer to the CPU core pipeline.

A detection circuit near the processor core can detect whether a single-threaded attacker executed on the core is performing a row hammer attack, but for multi-threaded attackers where threads on multiple cores each contribute to the row hammer attack, a detection circuit in the last level cache (LLC) can detect memory accesses from the multiple threads serviced by the LLC. Thus, one embodiment includes detection circuitry replicated across all LLC devices in the system. Other embodiments may include multiple detection circuits in multiple locations within the processor core, within the memory controller, and/or between the processor core and the memory.

In alternative embodiments, throttling of an aggressor thread in the processing core is performed in response to detecting of other types of attacks or adverse conditions, such as denial of service attacks detected in communication devices. For example, a communication device can include detection circuitry that keeps track of the number of packets sent to different devices and, in response to detecting an excessive number of packets being sent by the same thread to a target destination, enable throttling of an aggressor thread or threads that are responsible for sending the packets. In this case, the detection circuit in the communication device transmits an indication of the aggressor thread to the processing core executing the aggressor thread, and the processing core responds by throttling the thread.

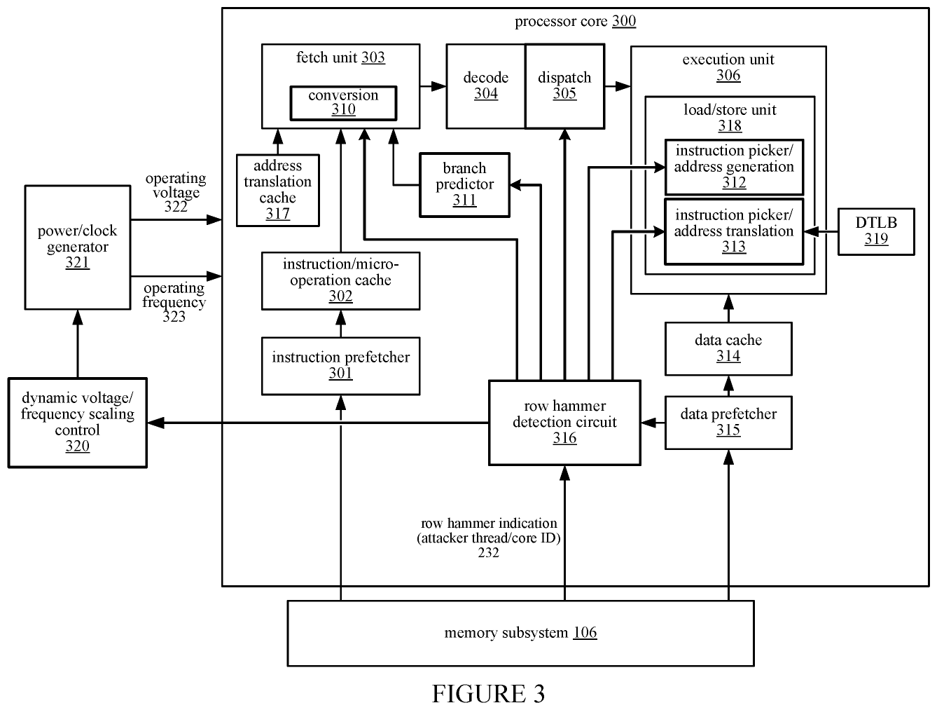

FIG. 3 illustrates circuit components in an embodiment of a processor core 300 that implements mechanisms for throttling aggressor threads that are performing row hammer attacks. As illustrated in FIG. 3, the processor core 300 includes a detection circuit 316 that detects row hammering based on observing outgoing memory requests. The detection circuit 316 operates in a similar manner as detection circuit 210, but counts each activation of a memory row prior to transmission of a memory request for performing the activation to the memory device via the interconnect (e.g., bus 101), thus allowing for earlier detection of row hammer attacks. In some embodiments, the row hammer detection circuit 316 also receives indications of row hammering from one or more detection circuits (e.g., detection circuit 210) elsewhere in the system 100 and propagates these indications to other components in the core 300 to enable the appropriate throttling mechanisms.

When an aggressor thread performs a row hammer attack, the attack is detected by the row hammer detection circuit 316 or 210 when a number of activations of a memory row exceeds the threshold number of activations for a time period. The core 300 responds to the row hammer attack by throttling (i.e., slowing down) execution of the indicated aggressor thread in one or more pipeline stages so that memory activations issued by the thread are less frequent and therefore less likely to corrupt data stored in adjacent memory rows. Throttling of the aggressor thread can be accomplished by slowing execution of all threads being executed in the processor core 300, including the aggressor thread, or by slowing execution of the only aggressor thread, in stages where its instructions are identified by its thread identifier.

One pipeline stage at which the processor core 300 performs throttling of aggressor threads is the fetch stage, where instructions are fetched from memory prior to execution. The fetch unit 303 contains the circuitry for fetching instructions, and fetches instructions according to input from the branch predictor 311, which predicts which instructions are likely to be executed next. When row hammering is detected, the detection circuit 316 signals the branch predictor 311 to reduce the throughput of predictions for the aggressor thread. Then, the branch predictor 311 throttles instruction execution for the aggressor thread by reducing the number of branch predictions for the aggressor thread. As a result, generation of the prediction window, which includes the next instructions to be fetched, is throttled. This delays fetching and execution of the instructions of the aggressor thread.

Once the prediction window is identified, the fetch unit 303 fetches the instructions in the window. Instruction addresses are translated, and then fetched from the memory subsystem 106 (i.e., by instruction prefetcher 301). Address translations are cached in the address translation cache 317, and instructions and micro-operations are cached in the instruction/micro-operation cache 302 to lower access latency. Thus, another way to throttle instruction execution for the aggressor thread at the fetch stage is by converting hits in the address translation cache 317 or instruction cache or micro-operation cache 302 to misses. The conversion of cache hits to misses is performed by conversion logic 310 in the fetch unit 303.

Even when address translations for instructions to be fetched are already in the address translation cache 317, the conversion logic 310 converts the cache hits to cache misses. As a result, the address translation is retrieved from lower levels of cache or from the memory subsystem 106. This results in increased latency for the address translation step. The delay in the instruction address translation increases latency in the fetch stage, thus throttling execution of the instructions that are eventually fetched.

Similarly, even when the instructions for the aggressor thread are already present in the micro-operation cache or the instruction cache, the conversion logic 310 converts cache hits for the aggressor thread into misses, causing the instructions to be fetched from higher levels in the memory hierarchy. This also increases the latency of the instruction fetch operation. Consequently, the execution of instructions for the aggressor thread that is causing the row hammering activations is delayed. Converting instruction cache or micro-operation cache hits to misses does not cause correctness issues because instructions lines are not modified and are always clean; thus, instructions fetched from upper levels of the memory hierarchy will not be stale. Converting hits to misses for the address translation cache 317 hits can be done independently from converting hits to misses in the instruction/micro-operation cache 302. Thus, different embodiments may enable either or both of these mechanisms depending on the amount of throttling desired.

After instructions are fetched, they are decoded in the decode unit 304. After decoding, the instructions are dispatched by the dispatch unit 305 for execution in the execution unit 306. Throttling of row hammering aggressor threads can also be performed at the dispatch stage, by delaying the dispatch of one or more instructions of the aggressor thread. When row hammering is detected, the detection circuit 316 communicates the thread identifier of the aggressor thread or threads to the dispatch unit 305. The dispatch unit 305 responds by throttling the identified threads by delaying the dispatch of their instructions to the execution unit 306 by one or more cycles. In one embodiment, the dispatch unit 305 also utilizes the same delay mechanism for balancing shared pipeline resources between threads.

Once an instruction has been dispatched, the instruction is sent to the execution unit 306, which includes circuitry for executing the different types of instructions. In particular, the load/store unit 318 executes all memory access instructions (i.e., load and store instructions), including those participating in row hammer attacks, and is also responsible for generating virtual addresses for the memory access instructions and translating the virtual addresses to physical addresses. Thus, stages in the load/store unit 318 at which throttling can be performed include the virtual address generation stage and the address translation stage. In one embodiment, the load/store unit 318 responds to an indication of a row hammer attack by throttling virtual address generation and/or memory address translation for memory access instructions from the identified aggressor thread to mitigate the row hammer attack by slowing down memory activations issued from the thread.

In one embodiment, the virtual address generation (AGEN) stage 312 that generates the virtual addresses for memory access instructions is throttled by slowing down the instruction pickers dedicated to picking instructions for address generation. Load and store instructions progress to the virtual address generation stage when selected by the instruction pickers 312, which select instructions from a given thread every n cycles. Thus, reconfiguring the instruction pickers 312 to increase the value of n for the aggressor thread reduces the rate at which memory access instructions are selected for virtual address generation. This delays the generation of virtual addresses for the memory access instructions issued by the aggressor thread, which in turn reduces the rate of memory row activations to a level that is less than the row hammer threshold.

In one embodiment, the instruction picker logic 312 selects instructions for different threads at the same rate without regard to their thread identifiers. This type of instruction picker logic 312 is still able to mitigate row hammer attacks by increasing the value of n for all threads. The virtual address generation is then delayed for all threads, including the aggressor thread. While such an embodiment may throttle non-aggressor threads along with the aggressor thread when row hammering is detected, the instruction picker logic is simpler and faster for the majority of the time when row hammering is not detected.

In one embodiment, the address translation stage 313 translates the virtual address to a physical address (by accessing the level 1 (L1) data translation lookaside buffer (DTLB) 319). The address translation stage 313 is also able to throttle aggressor threads by picking load or store instructions for accessing the L1 DTLB 319 every n cycles. The address translation stage instruction pickers 313 similarly respond to a row hammer attack by increasing the number of cycles n defining the period at which instructions are picked for accessing the DTLB 319, thus delaying memory address translation and overall execution of load and store instructions from the aggressor thread.

In addition, the address translation logic 313 can also throttle the execution of memory access instructions by converting cache hits in the DTLB 319 into misses. When translating a virtual address to a physical address, the address translation logic 313 looks up the translation in the DTLB. When the instructions are being throttled, the address translation logic 313 converts one or more hits (indicating that a requested address translation is present in the DTLB 319) into misses (indicating that the address translation is not present in the DTLB 319). As a result, the translation is retrieved from more distant levels of cache or memory in the memory hierarchy. This delays generation of the physical address for the memory access instruction, and increases execution latency.

In one embodiment, the process core 300 supports dynamic voltage and frequency scaling (DVFS), such that its operating voltage and clock frequency can be changed during operation. The operating voltage 322 and frequency 323 are provided from the power and clock generator circuitry 321, which adjusts its outputs 322 and 323 according to input from the DVFS control 320. The DVFS control 320 receives an indication from the detection circuit 316 that a row hammer attack is being carried out by an aggressor thread being executed in the core 300. The DVFS control responds by decreasing the operating frequency 323 of the processor core 300 so that instruction execution for the aggressor thread is throttled. Since the processor core 300 operates at a lower clock frequency, the rate of execution of memory access instructions from all threads executed in the processor core 300 also decreases. The operating frequency is lowered so that the rate of memory row activation also decreases below the row hammer threshold.

If the aggressor thread is being executed in a different frequency domain than other threads (e.g., victim threads), then it is possible to throttle the aggressor thread via decreasing the operating frequency 323 without degrading performance for the other threads. However, even if the aggressor thread and other threads, such as victim threads, are being executed in the same frequency domain, throttling in this manner still mitigates the row hammer attack even if victim threads are also throttled.

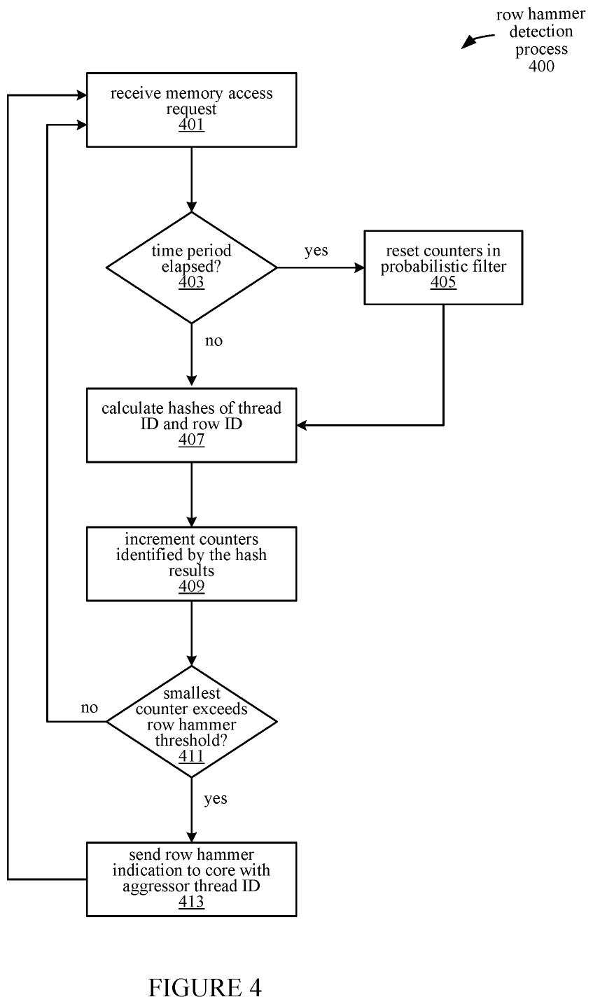

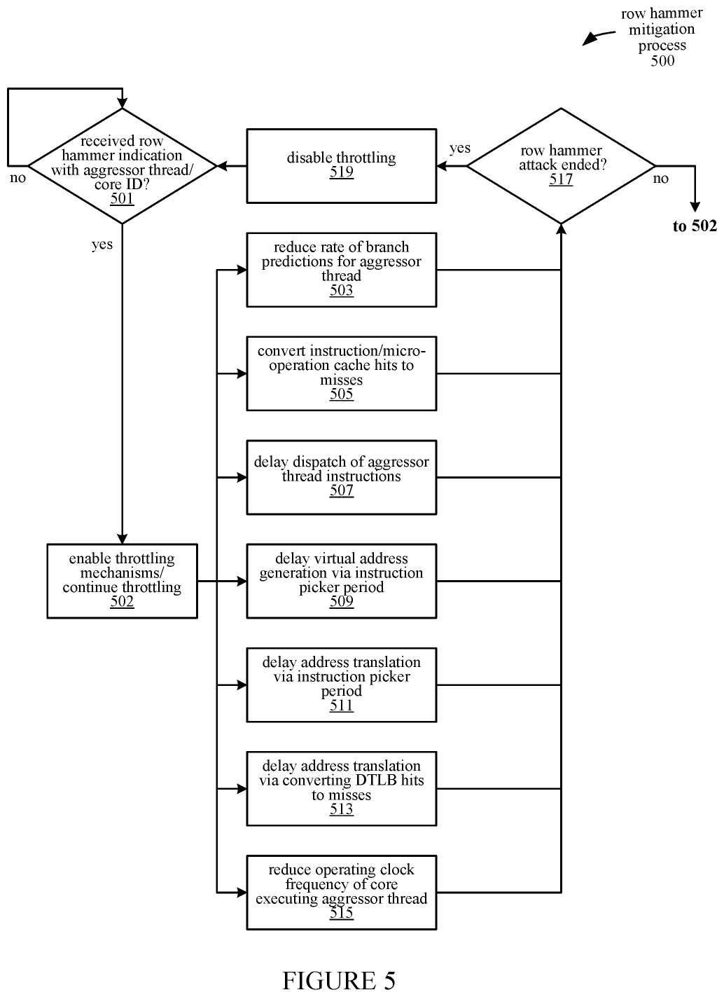

FIGS. 4 and 5 are flow diagrams illustrating a row hammer detection and mitigation process for detecting a row hammer attack and throttling the aggressor thread, according to an embodiment. The detection process 400 and mitigation process 500 are performed by components in the computing system 100, including the row hammer detection circuit 210 and/or 316, the processor core 300, etc.

The row hammer detection process 400 begins at block 401. At block 401, the detection circuit 210 or 232 receives a memory access request for reading or writing data in one of the memory rows 106.1-106.N in memory 106. The detection circuit 210 counts the number of activations of each memory row over a time period (e.g., the most recent w cycles). At block 403, if the time period has elapsed, then at block 405, then the detection circuit 210 resets the counters in the probabilistic filter 211. Continuing the example, the counters would thus be reset when w cycles have passed since the last reset. At block 403, if the time period has not elapsed, then the counters are not reset. From block 403 or 405, the process 400 continues at block 407.

At block 407, the hash engine 213 calculates hash results based on a combination of the memory row identifier for the memory row being activated by the memory request and the thread identifier of the thread issuing the memory request. In alternative embodiments, the core identifier of the core executing the thread is used instead of the thread identifier. In one embodiment where the filter 211 is implemented as a counting Bloom filter, the hash engine 213 calculates k hash results by applying each of k hash functions to the row identifier concatenated with the thread identifier.

At block 409, the counters in the probabilistic filter 211 that are identified by the hash results are incremented. Continuing the previous example, k counters each corresponding to one of the k hash results, are each incremented in response to the memory activation observed at block 401. At block 411, the comparison logic 212 determines whether the lowest count value among the counters exceeds the row hammer threshold. This indicates that the number of activations of the memory row within the time period is greater than the threshold number of activations for row hammering to be detected. If the lowest count value does not exceed this row hammer threshold, then the process returns to block 401 to continue monitoring incoming memory access requests. Otherwise, if the lowest count value exceeds the row hammer threshold, the process 400 continues at block 413.

At block 413, since the number of activations has exceeded the row hammer threshold, the detection circuit 210 sends an indication 232 to the processor core 300 that row hammering has been detected. The indication 232 includes the thread identifier of the aggressor thread to be throttled by the core 300. In an alternative embodiment, the indication 232 needs not include the thread identifier of the aggressor thread, but is sent to the processor core 300 that is executing the thread so that the processor core 300 throttles execution of all of its threads.

From block 413, the process 400 returns to block 401 to continue monitoring incoming memory requests. Blocks 401-413 thus repeat to continuously monitor incoming memory accesses to detect row hammering of the memory 106. Blocks 401-413 can also be performed by detection circuit 316 instead of detection circuit 210, or by a detection circuit located in another part of the system 100.

In alternative embodiments, a process similar to process 400 is performed to detect other types of attacks or adverse conditions, such as denial of service attacks being carried out by an aggressor thread. For example, the detection process may be performed using a counting Bloom filter to keep track of the number of messages transmitted to particular destinations within a time period (e.g., the most recent w cycles) using destination addresses instead of memory row identifiers. When the number of messages sent to a target address within the time period exceeds a threshold, a denial of service attack is detected and the aggressor thread's identifier is communicated to its host processor core for throttling.

FIG. 5 illustrates a row hammer mitigation process 500 that is performed in response to the row hammer indication 232, according to an embodiment. The process 500 is performed by components in the processor core 300, such as the detection circuit 316, branch predictor 311, dispatch stage 305, etc., and by other components such as the DVFS control 320.

Block 501 repeats until the row hammer detection circuit 316 detects row hammering or receives an indication that another detection circuit (e.g., detection circuit 210) has detected row hammering. When row hammering is detected by the detection circuit 210, 316, or another detection circuit elsewhere in the system 100, the processor core 300 responds by throttling instruction execution for the aggressor thread issuing the activations. The core 300 performs the throttling by slowing down execution of the aggressor thread specifically, or by slowing down execution of all threads being executed in the core, including the aggressor thread. When row hammering is detected, then from block 501, the processor core 300 enables one or more throttling mechanisms as provided at block 502, and performs the corresponding throttling operations represented in some or all of the blocks 503-515. The throttling mechanisms can be enabled concurrently and independently of each other. In one embodiment, a sufficient number of throttling mechanisms are enabled and/or the severity of throttling performed by each mechanism is selected to reduce the rate of activations of the targeted memory rows to a level that is below the row hammering threshold.

At block 503, the branch predictor 311 in the processor core 300 throttles the execution of instructions of the aggressor thread in the fetch stage by reducing the rate of branch predictions to reduce the instruction fetch rate. At block 505, instruction execution for the aggressor thread is throttled in the fetch stage by reducing converting at least one instruction cache hit to an instruction cache miss to reduce an instruction fetch rate of the aggressor thread.

At block 507, throttling instruction execution for the indicated aggressor thread is performed at the dispatch stage 305 by delaying dispatch of one or more instructions in the thread. In one embodiment, the period length in cycles for dispatching instructions is increased for instructions coming from the aggressor thread.

At block 509, the throttling of instruction execution for the aggressor thread is performed by the load/store units in the execution stage 318 by delaying generation of one or more virtual addresses for one or more memory access (i.e., load or store) instructions in the aggressor thread. Generation of the virtual addresses is delayed by reconfiguring instruction pickers 312 for the virtual address generation unit to wait a greater number of cycles before selecting each next instruction for virtual address generation (i.e., increasing the instruction picking period).

At blocks 511 and 513, instruction execution for the aggressor thread is throttled by delaying memory address translation (converting the virtual address to a physical address) for one or more memory access instructions in the aggressor thread. Address translation is delayed by increasing the picking period for an instruction picker 313 that selects instructions for address translation, as provided at block 511, and/or converting hits in the DTLB 319 into misses, as provided at block 513.

At block 515, execution of instructions for the aggressor thread is throttled by decreasing a clock frequency of the processor core 300 executing the aggressor thread. The clock frequency is adjusted by the DVFS control 320 in response to the indication 232 of the row hammer attack. In one embodiment, the DVFS control 320 controls the operating frequency for multiple frequency domains, and the indication 232 received by the DVFS control 320 indicates which domain to throttle (e.g., processor core 300 that is executing the aggressor thread).

At block 517, if the row hammer attack has not ended, the process 500 returns to block 502 to continue throttling the aggressor thread. The end of the row hammering attack is detected when the processing core receives an indication from the detection circuit 210 or 316 that the row hammering has ended, where such indication is generated by the detection circuit 210 or 316 when activations of the memory row have decreased below the row hammering threshold. In alternative embodiments, the row hammering can be determined to have ended after a timeout has elapsed since the row hammer indication 232 was received, after the aggressor thread is terminated, or other conditions. At block 517, if the row hammer attack has ended, then the throttling mechanisms are disabled at block 519. From block 519, the process 500 returns to block 501 to continue monitoring for indications of row hammer attacks.

As used herein, the term “coupled to” may mean coupled directly or indirectly through one or more intervening components. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Certain embodiments may be implemented as a computer program product that may include instructions stored on a non-transitory computer-readable medium. These instructions may be used to program a general-purpose or special-purpose processor to perform the described operations. A computer-readable medium includes any mechanism for storing or transmitting information in a form (e.g., software, processing application) readable by a machine (e.g., a computer). The non-transitory computer-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory, or another type of medium suitable for storing electronic instructions.

Additionally, some embodiments may be practiced in distributed computing environments where the computer-readable medium is stored on and/or executed by more than one computer system. In addition, the information transferred between computer systems may either be pulled or pushed across the transmission medium connecting the computer systems.

Generally, a data structure representing the computing system 100 and/or portions thereof carried on the computer-readable storage medium may be a database or other data structure which can be read by a program and used, directly or indirectly, to fabricate the hardware including the computing system 100. For example, the data structure may be a behavioral-level description or register-transfer level (RTL) description of the hardware functionality in a high level design language (HDL) such as Verilog or VHDL. The description may be read by a synthesis tool which may synthesize the description to produce a netlist including a list of gates from a synthesis library. The netlist includes a set of gates which also represent the functionality of the hardware including the computing system 100. The netlist may then be placed and routed to produce a data set describing geometric shapes to be applied to masks. The masks may then be used in various semiconductor fabrication steps to produce a semiconductor circuit or circuits corresponding to the computing system 100. Alternatively, the database on the computer-readable storage medium may be the netlist (with or without the synthesis library) or the data set, as desired, or Graphic Data System (GDS) II data.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be in an intermittent and/or alternating manner.

In the foregoing specification, the embodiments have been described with reference to specific exemplary embodiments thereof. It will, however, be evident that various modifications and changes may be made thereto without departing from the broader scope of the embodiments as set forth in the appended claims. The specification and drawings are, accordingly, to be regarded in an illustrative sense rather than a restrictive sense.

What is claimed is:

1. A method, comprising:
receiving an indication that a number of activations of a memory structure exceeds a threshold number of activations for a time period; and
in response to the indication, throttling instruction execution for a thread issuing the activations.

2. The method of claim 1, wherein:
the memory structure is a memory row in a dynamic random access memory module; and
the method further comprises:
in response to detecting that the number of activations is greater than the threshold number of activations for the time period, communicating a thread identifier of the thread to a processor core executing the thread.

3. The method of claim 1, further comprising:
throttling instruction execution for the thread by reducing an instruction fetch rate of the thread by lowering a rate of branch predictions for the thread.

4. The method of claim 1, further comprising:
throttling instruction execution for the thread by reducing an instruction fetch rate of the thread by converting at least one instruction cache hit to an instruction cache miss.

5. The method of claim 1, further comprising:
throttling instruction execution for the thread by delaying dispatch of one or more instructions in the thread.

6. The method of claim 1, further comprising:
throttling instruction execution for the thread by delaying generation of a virtual address for at least one memory access instruction in the thread.

7. The method of claim 1, further comprising:
throttling instruction execution for the thread by delaying a memory address translation for at least one memory access instruction in the thread.

8. The method of claim 1, further comprising:
throttling instruction execution for the thread by decreasing a clock frequency of a processor core executing the thread.

9. A processing device configured to:
receive an indication that a number of activations of a memory structure exceeds a threshold number of activations for a time period; and
in response to the indication, throttle instruction execution for a thread issuing the memory activations.

10. The processing device of claim 9, further comprising:
a branch prediction circuit configured to throttle the instruction execution for the thread by lowering a rate of branch predictions for the thread.

11. The processing device of claim 9, further comprising:
instruction fetch circuitry configured to throttle the instruction execution for the thread by converting at least one instruction cache hit to an instruction cache miss.

12. The processing device of claim 9, further comprising:
a dispatch circuit configured to throttle the instruction execution for the thread by delaying dispatch of one or more instructions in the thread.

13. The processing device of claim 9, further comprising:
an instruction picker circuit configured to throttle the instruction execution for the thread by delaying generation of a virtual address for at least one memory access instruction in the thread.

14. The processing device of claim 9, further comprising:
an address translation circuit configured to throttle the instruction execution for the thread by delaying a memory address translation for at least one memory access instruction in the thread.

15. The processing device of claim 9, further configured to:
throttle the instruction execution for the thread by operating at a lower clock frequency.

16. A computing system, comprising:
a detection circuit configured to generate an indication when a number of activations of a memory structure exceeds a threshold number of activations for a time period; and
a processing unit coupled with the detection circuit and configured to, in response to receiving the indication, throttle execution of a thread causing the activations.

17. The computing system of claim 16, further comprising:
a memory controller comprising the detection circuit, wherein the memory controller is configured to transmit the indication via an interconnect to the processing unit.

18. The computing system of claim 16, wherein for each activation of the activations:
the detection circuit is further configured to count the activation prior to transmission of a memory request for performing the activation to the memory device via an interconnect.

19. The computing system of claim 16, wherein the detection circuit is further configured to:
count the number of activations of the memory structure during the time period;
associate the number of activations with a thread identifier of the thread; and
communicate the thread identifier to the processing unit when the number of activations exceeds the threshold number of activations for the time period.

20. The computing system of claim 16, wherein:
the memory structure is a memory row; and
the detection circuit is further configured to:
calculate a hash based on a thread identifier of the thread and a row identifier of the memory row, and
associate the hash with a count value representing the number of activations.
